(19) United States
(12) Patent Application Publication
(10) Pub. No.: US 2004/0167951 A1
(43) Pub. Date: Aug. 26, 2004

(54) Control method, controller, recording medium recording control program, numerical calculation method, numerial calculator and recording medium recording numerical calculation program

(75) Inventors: Atsuhiro Tamura, Osaka (JP); Kazuo Kikuchi, Tokyo (JP); Akihiro Ida, Osaka (JP)

Correspondence Address: NIXON PEABODY, LLP, 401 9TH STREET, NW, SUITE 900, WASINGTON, DC, 20004-2128, US

(73) Assignees: Kazuo Kikuchi, Tokyo (JP); VINAS Co., Ltd., Osaka (JP)

(21) Appl. No.: 10/367,684

(22) Filed: Feb. 19, 2003

(51) Int. Cl. G06F 1/00

(52) U.S. Cl. 708/446

(57) ABSTRACT

A·U+B(U)=f, wherein A is a linear differential operator, B is a nonlinear differential operator, and f is an inhomogeneous term (source term) in a nonlinear partial differential equation to be satisfied by a physical quantity U, is solved by successive approximation. In calculation, (f−A·U^{m}−B(U^{m})) is given as a nonlinear residual rr of an approximate solution U^{m}, wherein m is the number of repeating times, and the approximate solution U^{m} is repeatedly corrected so as to reduce a norm of a nonlinear residual r^{m+1} employed in a subsequent step.

### BACKGROUND OF THE INVENTION

The present invention relates to a technique to control a nonlinear operation for a physical quantity such as a pressure or a temperature, and more particularly, it relates to a control technique using successive approximation algorithm. Also, it relates to a numerical calculation technique for a physical quantity.

In the technique to control a nonlinear operation for a physical quantity such as a pressure or a temperature, successive approximation algorithm has been conventionally used. In the successive approximation algorithm, successive approximation is repeated on the basis of a variety of optimization theories so as to obtain an optimum solution through numerical calculation.

In the conventional successive approximation algorithm, however, it is premised that a nonlinear operation can be expressed by accumulating small linear operations obtained by linearizing a nonlinear equation. Therefore, in the case where a phenomenon with strong nonlinearity occurs, the calculation should be repeated a massive number of times for obtaining solutions of respective parameters used for determining the control operation. Accordingly, rapid and highly precise control is disadvantageously difficult due to the time spent on the calculation, or the calculation is diverged while it is repeated and hence a solution cannot be obtained, which disables the control operation.

### SUMMARY OF THE INVENTION

An object of the invention is providing a control technique and a numerical calculation technique using successive approximation algorithm for controlling a nonlinear operation more rapidly and more precisely than in the conventional technique.

Specifically, according to the invention, as a technique to control or numerically calculate a physical quantity U, A·U+B(U)=f, wherein A is a linear differential operator, B is a nonlinear differential operator, and f is an inhomogeneous term (source term) in a nonlinear partial differential equation to be satisfied by the physical quantity U, is solved by using successive approximation. In the calculation, (f−A·U^{m}−B(U^{m})) is given as a nonlinear residual r^{m} of an approximate solution U^{m}, wherein m is the number of repeating times, and the approximate solution U^{m} is repeatedly corrected so as to reduce a nonlinear residual r^{m+1} employed in a subsequent step.

In the control or numerical calculation technique of this invention, the nonlinear term B(U) is expressed as follows:

$$B ( U ) = {\sum }_{n} {N}^{n} ( U ) {D}^{n} \cdot U$$

$${N}^{n} ( U ) ⋯$$

. . . nonlinear coefficient,

$${D}^{n} ( U ) ⋯$$

. . . differential operator N(U^{m}+φ) is expanded with respect to the approximate solution U^{m} and a perturbation quantity φ by the Taylor expansion or the mean value theorem, to give the following with terms higher than φ² ignored:

$$B ( {U}^{m} ) + φ ) ≅ B ( {U}^{m} ) + L \cdot φ + φ {\sum }_{n} {{N}^{′}}^{n} ( {U}^{m} ) {D}^{n} \cdot φ , … \\ L \cdot φ ≡ {\sum }_{n} [ {N}^{n} ( {U}^{m} ) {D}^{n} + {{N}^{′}}^{n} ( {U}^{m} ) {D}^{n} \cdot {U}^{m} ] φ , \\ {{N}^{′}}^{n} ( {U}^{m} ) ≡ {[ \frac{\partial {N}^{n} ( U )}{\partial U} ]}_{U = {U}^{m}} \qquad ( 4 )$$

and the following first process and second process are preferably repeatedly executed until the approximate solution U^{m} is converged. The first process includes the steps of setting U⁰ as an initial value of the physical quantity U; setting 0 as an initial value of the number m of repeating times and (f−A·U⁰−B(U⁰)) as an initial value r⁰ of a nonlinear residual r; and obtaining a predicted approximate value φ^{m} of the following equation through repeated calculations while incrementing the number m of repeating times:

$$[ A + L + φ {\sum }_{n} {{N}^{′}}^{n} ( {U}^{m} ) {D}^{n} ] \cdot φ = {r}^{m} \qquad ( 5 )$$

The second process includes the steps of obtaining a corrected approximate value φ^{m} for minimizing a norm of a nonlinear residual r^{m+1} on the basis of a predicted approximate values φ^{m} and corrected approximate values φ^{m-1}, . . . , and φ^{m-Lmax+1}, wherein Lmax is an integer of 2 or more; giving (U^{m}+φ^{m}) as an approximate solution U^{m+1}; and giving (f−A·U^{m+1}−B(U^{m+1})) as the nonlinear residual r^{m+1}.

Alternatively, in the control or numerical calculation technique of this invention, the nonlinear term B(U) is expressed as follows:

$$B ( U ) = {\sum }_{n} {N}^{n} ( U ) {D}^{n} \cdot U$$

$${N}^{n} ( U ) ⋯$$

. . . nonlinear coefficient,

$${D}^{n} ( U ) ⋯$$

. . . differential operator N(U^{m}+φ)) is expanded with respect to the approximate solution U^{m} and a perturbation quantity φ by the Taylor expansion or the mean value theorem, to give the following with terms higher than φ ignored:

B(U^{m}+φ)≅B(U^{m})+L·φ, (4′)

$$L \cdot φ ≡ {\sum }_{n} [ {N}^{n} ( {U}^{m} ) {D}^{n} + {{N}^{′}}^{n} ( {U}^{m} ) {D}^{n} \cdot {U}^{m} ] φ , \\ {{N}^{′}}^{n} ( {U}^{m} ) ≡ {[ \frac{\partial {N}^{n} ( U )}{\partial U} ]}_{U = {U}^{m}}$$

and the following first process and second process are preferably repeatedly executed until the approximate solution U^{m} is converged. The first process includes the steps of setting U⁰ as an initial value of the physical quantity U; setting 0 as an initial value of the number m of repeating times and (f−A·U⁰−B(U⁰)) as an initial value r⁰ of a nonlinear residual r; obtaining a predicted approximate value φ^{m} of [A+L]φ=r^{m} through repeated calculations while incrementing the number m of repeating times. The second process includes the steps of obtaining a corrected approximate value φ^{m} for minimizing a norm of a nonlinear residual r^{m+1} on the basis of a predicted approximate value φ^{m} and corrected approximate values φ^{m-1}, . . . and φ^{m-Lmax+1}, wherein Lmax is an integer of 2 or more; giving (U^{m}+φ^{m}) as an approximate solution U^{m+1}; and giving (f−A·U^{m+1}−B(U^{m+1})) as the nonlinear residual r^{m+1}.

### BRIEF DESCRIPTION OF THE DRAWINGS

FIG. 1 is a block diagram for showing the architecture of a controller according to an embodiment of the invention;

FIG. 2 is a flowchart for showing procedures in a control method according to Embodiment 1 of the invention;

FIG. 3 is a flowchart for showing procedures in a control method according to Embodiment 2 of the invention;

FIGS. 4A and 4B are diagrams for showing an example of grid generation to which algorithm of this invention is applied;

FIGS. 5A and 5B are graphs for comparing the convergence rate of the example shown in FIGS. 4A and 4B;

FIGS. 6A and 6B are diagrams for showing another example of the grid generation to which the algorithm of this invention is applied; and

FIGS. 7A and 7B are graphs for comparing the convergence rate of the example shown in FIGS. 6A and 6B.

### DETAILED DESCRIPTION OF THE INVENTION

Preferred embodiments of the invention will now be described with reference to the accompanying drawings.

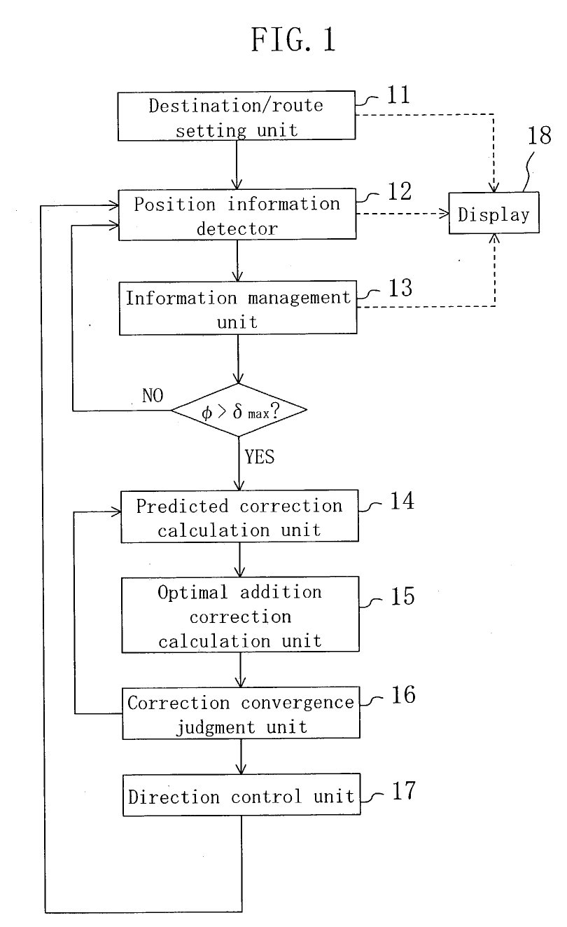

FIG. 1 is a block diagram for showing the architecture of a controller according to an embodiment of the invention, and this architecture is shown as an example of application of a control technique according to this invention to vehicle automatic drive control. It is assumed in FIG. 1 that a vehicle is equipped with a circuit for allowing the vehicle to drive to a destination along an orbit set by a destination/route setting unit 11 within an allowable error range. During the drive, drive information such as position/azimuth information and a driving speed are detected by a position information detector 12. Also, information such as a set value and a driving state are displayed in a real-time manner on a display 18.

A shift φ between the position of the vehicle and the orbit is always monitored by information management unit 13. If the shift φ exceeds an allowable value δₘₐₓ, by using the drive information obtained at this point as starting values, optimization parameter control of an azimuth angle, angular acceleration, a speed, acceleration and the like, namely, optimization means for returning the vehicle to the orbit, is simulated by using algorithm of this invention.

As a characteristic of this invention, a nonlinear residual is directly used in repeated calculations of the successive approximation algorithm.

Embodiment 1

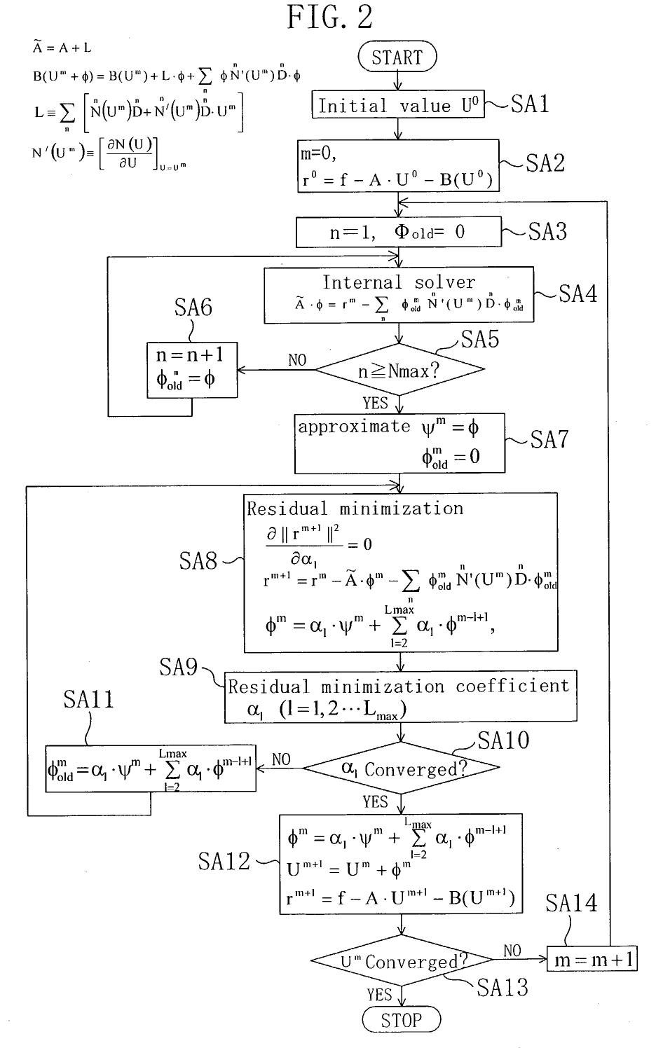

FIG. 2 is a flowchart for showing procedures in a control method according to Embodiment 1 of the invention.

<Formulation of Nonlinear Residual Equation>

Assuming that a physical quantity desired to obtain is U and that a linear differential operator is A, a nonlinear differential operator is B and an inhomogeneous term (source term) is f in a nonlinear partial differential equation to be satisfied by the physical quantity U, an equation to be solved is expressed as follows:

A−U+B(U)=f (1)

This equation can be generally solved by linearly approximating a nonlinear term B(U) and by using the successive approximation such as the SOR method or the ADI method.

In this embodiment, the following solution method is employed:

The solution U of equation (1) is represented by using an approximate solution U^{m} and a perturbation quantity φ (namely, a difference from a true solution) as follows:

U=U^{m}+φ (2)

Also, a nonlinear residual r^{m} of the approximate solution U^{m} is defined as follows:

r^{m}=f−A·U^{m}−B(U^{m}) (3)

In the solution method of this embodiment, the perturbation quantity φ is obtained and the approximate solution U^{m} is corrected so as to reduce a norm of a nonlinear residual r^{m+1} employed in a subsequent step, thereby obtaining the true solution U of equation (1).

When the nonlinear term B(U) is represented by using a nonlinear coefficient and a differential operator as follows:

$$B ( U ) = {\sum }_{n} {N}^{n} ( U ) {D}^{n} \cdot U$$

$${N}^{n} ( U ) ⋯$$

. . . nonlinear coefficient,

$${D}^{n} ( U ) ⋯$$

. . . differential operator N(U^{m}+φ) is expanded by the Taylor expansion or the mean value theorem, so as to be expressed, with terms higher than φ² ignored, as follows:

$$B ( {U}^{m} ) + φ ) ≅ B ( {U}^{m} ) + L \cdot φ + φ {\sum }_{n} {{N}^{′}}^{n} ( {U}^{m} ) {D}^{n} \cdot φ , … \\ L \cdot φ ≡ {\sum }_{n} [ {N}^{n} ( {U}^{m} ) {D}^{n} + {{N}^{′}}^{n} ( {U}^{m} ) {D}^{n} \cdot {U}^{m} ] φ , \\ {{N}^{′}}^{n} ( {U}^{m} ) ≡ {[ \frac{\partial {N}^{n} ( U )}{\partial U} ]}_{U = {U}^{m}} \qquad ( 4 )$$

On the basis of equations (1) through (4), the following holds:

A·(U^{m}+φ)+B(U^{m}+φ)=f

$$⇒ A \cdot ( {U}^{m} + φ ) + ( B ( {U}^{m} ) + L \cdot φ + φ {\sum }_{n} {{N}^{′}}^{n} ( {U}^{m} ) {D}^{n} \cdot φ ) = f \\ ⇒ [ A + L + φ {\sum }_{n} {{N}^{′}}^{n} ( {U}^{m} ) {D}^{n} ] \cdot φ = f - A \cdot {U}^{m} - B ( {U}^{m} ) = {r}^{m}$$

Accordingly, in order to obtain the perturbation quantity A, the following equation is solved:

$$[ A + L + φ {\sum }_{n} {{N}^{′}}^{n} ( {U}^{m} ) {D}^{n} ] \cdot φ = {r}^{m} \qquad ( 5 )$$

<Algorithm for Nonlinear Residual Cutting Method>

In the algorithm of this invention, a convergence solution of equation (5) is not to be obtained but, for example, from the following term on the left-hand side of equation (5):

$${φ}^{m} {\sum }_{n} {{N}^{′}}^{n} ( {U}^{m} ) {D}^{n} \cdot {φ}^{m}$$

φ^{m} is transposed in the form of φ^{m}_{old} to the right-hand side, so as to obtain the following linearized equation:

$$[ A + L ] \cdot φ = {r}^{m} - {φ}_{old}^{m} {\sum }_{n} {{N}^{′}}^{n} ( {U}^{m} ) {D}^{n} \cdot {φ}_{old}^{m}$$

This equation is solved by the ADI method or the like, so as to obtain a predicted approximate value φ^{m} through a minimum unit of repeated calculations with the steepest convergence gradient, and the obtained predicted approximate value φ^{m} is supplied to an optimization control routine. A series of operations are repeatedly executed until the execution result of the optimization control routine satisfies a predetermined condition.

<Optimization Control Routine>

Assuming that the number of repeating times is m, a synthesize perturbation quantity φ^{m} for minimizing the norm of the nonlinear residual and a new approximate solution U^{m+1} are defined as follows:

$${φ}^{m} = {α}_{1} {ψ}^{m} + {\sum }_{l = 2}^{ L max} {α}_{l} {φ}^{m - l + 1} \qquad ( 6 )$$

U^{m+1}=U^{m}+φ^{m} (7)

In equation (6), α₁(1=1, 2, 3, . . . , Lₘₐₓ) is a residual minimization coefficient, which is a constant obtained by a calculation method described later. The following minimization of the nonlinear residual is carried out so as to make the norm of the nonlinear residual smaller:

When the new approximate solution U^{m+1} is represented by equation (7), the nonlinear residual r^{m+1} of this approximate solution U^{m+1} is represented, on the basis of equation (3), as follows:

r^{m+1}=f−A·U^{m+1}−B(U^{m+1}) (8)

Equation (8) can be expressed by using equations (3) and (4) as follows:

$${r}^{m + 1} ≅ f - A \cdot ( {U}^{m} + {φ}^{m} ) - B ( {U}^{m} ) - L \cdot {φ}^{m} - {φ}^{m} {\sum }_{n} {{N}^{′}}^{n} ( {U}^{m} ) {D}^{n} \cdot {φ}^{m} \\ = {r}^{m} - [ A + L + {φ}^{m} {\sum }_{n} {{N}^{′}}^{n} ( {U}^{m} ) {D}^{n} ] \cdot {φ}^{m} \qquad ( 9 )$$

At this point, when

Ã=A+L (10)

equation (9) can be expressed as follows:

$${r}^{m + 1} = {r}^{m} - {φ}^{m} {\sum }_{n} {{N}^{′}}^{n} ( {U}^{m} ) {D}^{n} \cdot {φ}^{m} - \tilde{A} \cdot {φ}^{m} \qquad ( 11 )$$

When, for example, the L² norm is used as the norm for evaluating the amplitude of the nonlinear residual, a norm ∥r^{m+1}∥ of the nonlinear residual r^{m+1} is, in the three-dimensional case, given by the following equation as a square root of a sum of all the inner points of (r^{m+1})²:

$$‖ {r}^{m + 1} ‖ = \sqrt{{\sum }_{ijk} {( {r}^{m} - {φ}^{m} {\sum }_{n} {{N}^{′}}^{n} ( {U}^{m} ) {D}^{n} \cdot {φ}^{m} - \tilde{A} \cdot {φ}^{m} )}^{2}} \qquad ( 12 )$$

wherein i, j, and k represent a three-dimensional coordinate.

The residual minimization coefficient α₁(1=1, 2, 3, . . . , Lₘₐₓ) is determined so as to minimize the norm ∥r^{m+1} ∥ of the nonlinear residual r^{m+1} by the least squares method. Specifically, the following equation is to be satisfied:

$$\frac{\partial {‖ {r}^{m + 1} ‖}^{2}}{\partial {α}_{l}} = 0 ( l = 1 , 2 , 3 , ⋯ , {L}_{max} ) \qquad ( 13 )$$

Since the following term:

$${φ}^{m} {\sum }_{n} {{N}^{′}}^{n} ( {U}^{m} ) {D}^{n} \cdot {φ}^{m}$$

is present on the right-hand side of equation (12), equation (13) is nonlinear simultaneous equations with respect to α₁, and when this equation is numerically solved through repeated calculations through linear approximation, α₁ can be defined. When α₁ is defined, φ^{m} is found on the basis of equation (6), and U^{m+1} is found on the basis of equation (7). The method for calculating the residual minimization coefficient α₁ will be described later.

While incrementing the number m, similar routines are repeated, so as to attain convergence of the solution U for making zero or minimizing the norm of the nonlinear residual of equation (8).

Now, the control method of this embodiment will be described with reference to the flowchart of FIG. 2.

First, in step SA1, an initial value U⁰ of the physical quantity U to be obtained is set. In step SA2, the number m of repeating times is set to an initial value of 0, and an initial value r⁰ of the nonlinear residual r is set to (f−A·U⁰−B(U⁰)).

Thereafter, procedures of steps SA3 through SA14 are repeatedly executed with the number m of repeating times incremented until the approximate solution U^{m} is converged.

In steps SA3 through SA7, the approximate solution (predicted approximate value) φ^{m} of the following equation is obtained by using an internal solver that executes the successive approximation such as the ADI method or the SOR method by linearizing this equation:

$$[ \tilde{A} + φ {\sum }_{n} {{N}^{′}}^{n} ( {U}^{m} ) {D}^{n} ] \cdot φ = {r}^{m}$$

In this embodiment, the upper limit Nₘₐₓ of the number of repeating times of the successive calculations is set (steps SA5 and SA6).

When the predicted approximate value φ⁰ is obtained through the procedures of steps SA3 through SA7, the optimization routine is carried out by using this predicted approximate value φ⁰ so as to obtain a corrected value φ⁰ for minimizing a nonlinear residual r¹ of a subsequent step. By using this corrected value φ⁰, a primary approximate value U¹ of the physical quantity and a primary nonlinear residual r¹ can be obtained as follows on the basis of equations (2) and (3):

U¹=U⁰+φ⁰ (14)

r¹=f−A·U¹−B(U¹) (15)

In step SA13, the number m of repeating times is incremented, and the flow returns to step SA3, so as to repeat similar calculations. By repeating these procedures, (U², r²), (U³, r³), . . . , (U^{m}, r^{m}) . . . can be successively obtained, and the norm ∥r^{m}∥ of the nonlinear residual is reduced.

When the number of repeating times is m, an equation used for obtaining the predicted approximate value φ^{m} in step SA4 is as follows:

$$[ \tilde{A} + φ {\sum }_{n} {{N}^{′}}^{n} ( {U}^{m} ) {D}^{n} ] \cdot φ = {r}^{m}$$

Therefore, on the basis of the corrected approximate value φ^{m} having been optimized through the optimization control routine performed in steps SA8 through SA11, the following equations are obtained:

U^{m+1}=U^{m}+φ^{m}

r^{m+1}f−A·U^{m+1}−B(U^{m+1})

<Method for Obtaining Residual Minimization Coefficient α₁>

At this point, for simplifying the expression, δ is introduced as follows:

δ^{m}=φ^{m}

δ^{m-l+1}=φ^{m-l+1}(wherein l=2, 3, . . . , Lₘₐₓ)

In this case, the corrected approximate value φ^{m} is expressed as follows:

$${φ}^{m} = {\sum }_{l = 1}^{L max} {α}_{l} {δ}^{m - l + 1} \qquad ( 17 )$$

Therefore, the following equation holds:

$$\begin{matrix}{r}^{m + 1} = {r}^{m} - A \cdot {φ}^{m} - B ( {φ}^{m} ) \\ = {r}^{m} - \tilde{A} \cdot {φ}^{m} - {φ}^{m} {\sum }_{n} {N}^{n} ' ( {U}^{m} ) {D}^{n} \cdot {φ}^{m}\end{matrix} \qquad ( 18 )$$

When this equation is substituted in equation (17), the following is obtained:

$$\begin{matrix}{r}^{m + 1} = {r}^{m} - {\sum }_{l = 1}^{{L}_{max}} {α}_{l} \tilde{A} \cdot {δ}^{m - l + 1} - \\ {\sum }_{l = 1}^{{L}_{max}} {\sum }_{l ' = 1}^{{L}_{max}} ( {α}_{l} {α}_{l '} {δ}^{m - l ' + 1} {\sum }_{n} {N}^{n} ' ( {U}^{m} ) {D}^{n} \cdot {δ}^{m - l ' + 1} )\end{matrix} \qquad ( 19 )$$

The residual minimization coefficient α₁ is obtained by using the least squares method under a condition that the L² norm of the nonlinear residual of the (m+1)th order is to be minimized.

$$\begin{matrix}{‖ {r}^{m + 1} ‖}^{2} = {\sum }_{ijk} ( {r}^{m} - {\sum }_{l = 1}^{{L}_{max}} {α}_{l} \tilde{A} \cdot {δ}^{m - l + 1} - \\ { {\sum }_{l = 1}^{{L}_{max}} {\sum }_{l ' = 1}^{{L}_{max}} ( {α}_{l} {α}_{l '} {δ}^{m - l ' + 1} {\sum }_{n} {N}^{n} ' ( {U}^{m} ) {D}^{n} \cdot {δ}^{m - l ' + 1} ) )}^{2} \\ □\end{matrix} \qquad ( 20 )$$

When this equation is differentiated with respect to α₁, the following is obtained:

$$\frac{\partial {‖ {r}^{m + 1} ‖}^{2}}{\partial {α}_{l}} = 0 ( l = 1 , 2 , 3 , … , {L}_{max} ) \qquad ( 21 )$$

When this equation (21) is solved with respect to α₁, the residual minimization coefficient α₁ can be obtained. This equation is generally nonlinear simultaneous equations with respect to α₁ and is solved through linearization and repeated calculations. For example, when φ^{m} of the third term on the right-hand side of equation (18) is transposed in the form of φ^{m}_{old} to the right-hand side to be linearized and the following is defined:

$${\tilde{r}}^{m} = {r}^{m} - {φ}_{old}^{m} {\sum }_{n} {N}^{n} ' ( {U}^{m} ) {D}^{n} \cdot {φ}_{old}^{m} \qquad ( 22 )$$

the following equation holds:

$${r}^{m + 1} = {\tilde{r}}^{m} - {\sum }_{l = 1}^{{L}_{max}} {α}_{l} \tilde{A} \cdot {δ}^{m - l + 1} \\ {‖ {r}^{m + 1} ‖}^{2} = {\sum }_{ijk} {( {\tilde{r}}^{m} - {\sum }_{l = 1}^{{L}_{max}} {α}_{l} \tilde{A} \cdot {δ}^{m - l + 1} )}^{2} \qquad ( 23 )$$

When this equation is substituted in equation (21) and the resultant is differentiated with respect to α₁, the following is obtained:

$$\frac{\partial {‖ {r}^{m + 1} ‖}^{2}}{\partial {α}_{{l}^{′}}} = - 2 {\sum }_{ijk} [ {\tilde{r}}^{m} - \tilde{A} \cdot {\sum }_{l = 1}^{{L}_{max}} {α}_{l} {δ}^{m - l + 1} ] \tilde{A} \cdot {δ}^{m - {l}^{′} + 1} , \\ ( {l}^{′} = 1 , 2 , 3 , … , {L}_{max} ) \\ ∴ {\sum }_{ijk} {\sum }_{l = 1}^{{L}_{max}} {α}_{l} ( \tilde{A} \cdot {φ}^{m - l + 1} ) ( \tilde{A} \cdot {φ}^{m - {l}^{′} + 1} ) = {\sum }_{ijk} {\tilde{r}}^{m} ( \tilde{A} \cdot {φ}^{m - {l}^{′} + 1} ) , \\ ( {l}^{′} = 1 , 2 , 3 , … , {L}_{max} ) \qquad ( 24 )$$

When the Lₘₐₓ-element simultaneous linear equations given as equation (24) are solved, α₁ is temporarily obtained, and φ^{m} obtained by substituting the temporal α₁ in equation (17) is substituted in equation (22) in the form of φ^{m}_{old} again, and the resultant simultaneous linear equations given as equation (24) are solved again. Such repeated calculations are executed several times, so as to obtain the residual minimization coefficient α₁.

Embodiment 2

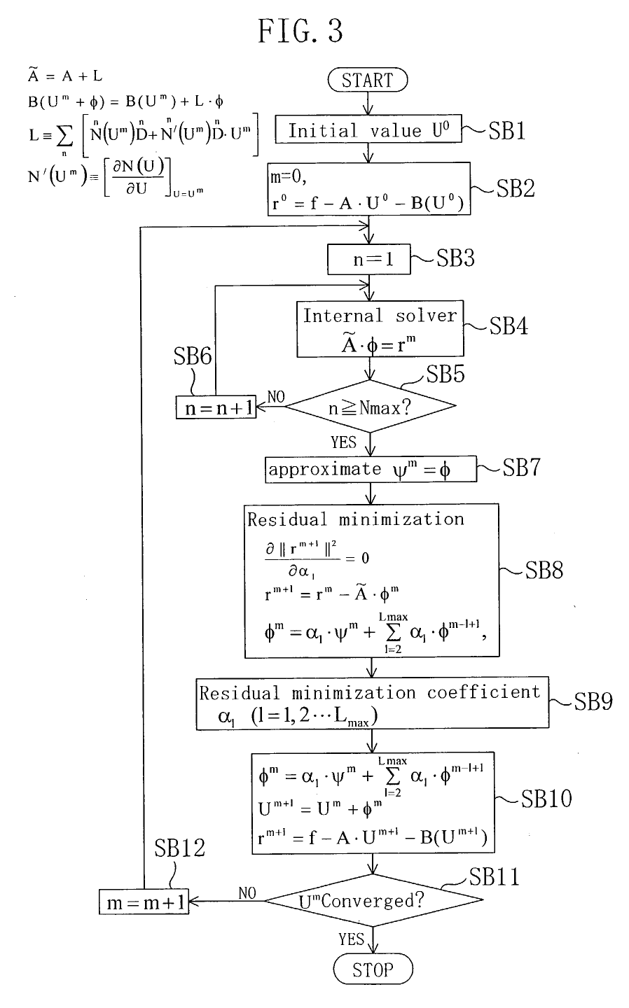

FIG. 3 is a flowchart for showing procedures in a control method according to Embodiment 2 of the invention.

<Formulation of Nonlinear Residual Equation>

Assuming that a physical quantity desired to obtain is U and that a linear differential operator is A, a nonlinear differential operator is B and an inhomogeneous term (source term) is f in a nonlinear partial differential equation to be satisfied by the physical quantity U, an equation to be solved is, as in Embodiment 1, as follows:

A·U+B(U)=f (1)

This equation can be generally solved by linearly approximating a nonlinear term B(U) and by using the successive approximation such as the SOR method or the ADI method.

In this embodiment, the following solution method is employed:

The solution of equation (1) is represented by using an approximate solution U^{m} and a perturbation quantity 0 (namely, a difference from a true solution) as follows:

U=U^{m}+φ (2)

Also, a nonlinear residual r^{m} of the approximate solution U^{m} is defined as follows:

r^{m}f−A·U^{m}−B(U^{m}) (3)

In the solution method of this embodiment, the perturbation quantity φ is obtained and the approximate solution U^{m} is corrected so as to reduce a nonlinear residual r^{m+1} employed in a subsequent step, thereby obtaining the true solution U of equation (1).

When the nonlinear term B(U) is represented by using a nonlinear coefficient and a differential operator as follows:

$$B ( U ) = {\sum }_{n} {N}^{n} ( U ) {D}^{n} \cdot U$$

$${N}^{n} ( U ) ⋯$$

. . . nonlinear coefficient,

$${D}^{n} ( U ) ⋯$$

. . . differential operator N(U^{m}+φ) is expanded by the Taylor expansion or the mean value theorem, so as to be expressed, with terms higher than φ ignored, as follows:

B(U^{m}+φ)≅B(U^{m})+L·φ, (4′)

$$L \cdot φ ≡ {\sum }_{n} [ {N}^{n} ( {U}^{m} ) {D}^{n} + {N}^{n} ' ( {U}^{m} ) {D}^{n} \cdot {U}^{m} ] φ , {N}^{n} ' ( {U}^{m} ) ≡ {[ \frac{\partial {N}^{n} ( U )}{\partial U} ]}_{U = {U}^{m}}$$

On the basis of equations (1) through (4′), the following holds:

A·(U^{m}+φ)+B(U^{m}+φ)=f

→A·(U^{m}+φ)+(B(U^{m})+L·φ)=f

→[A+L]·φ=f−A·U^{m}−B(U^{m})=r^{m}

Accordingly, in order to obtain the perturbation quantity φ, the following equation is solved:

[A+L]·φ=r^{m} (5′)

<Algorithm for Nonlinear Residual Cutting Method>

In the algorithm of this invention, a convergence solution of equation (5′) is not to be obtained but an equation obtained by linearizing the left-hand side of equation (5′) is solved by the ADI method or the like, so as to obtain a predicted approximate value φ^{m} through a minimum unit of repeated calculations with the steepest convergence gradient, and the obtained predicted approximate value φ^{m} is supplied to an optimization control routine. A series of operations are repeatedly executed until the execution result of the optimization control routine satisfies a predetermined condition.

<Optimization Control Routine>

Assuming that the number of repeating times is m, a synthesize perturbation quantity φ^{m} for minimizing the norm of the nonlinear residual and a new approximate solution U^{m+1} are defined as follows:

$${φ}^{m} = {α}_{1} {ψ}^{m} + {\sum }_{l = 2}^{{L}_{max}} {α}_{l} {φ}^{m - l + 1} \qquad ( 6 )$$

U^{m+1}=U^{m}+φ^{m} (7)

In equation (6), α₁(1=1, 2, 3, . . . , Lₘₐₓ) is a residual minimization coefficient, which is a constant obtained by a calculation method described later. The following minimization of the nonlinear residual is carried out so as to make the norm of the nonlinear residual smaller:

When the new approximate solution U^{m+1} is represented by equation (7), the nonlinear residual r^{m+1} of this approximate solution U^{m+1} is expressed, on the basis of equation (3), as follows:

r^{m+1}=f−A·U^{m+1}−B(U^{m+1}) (8)

Equation (8) can be expressed by using equations (3) and (4′) as follows:

$${r}^{m + 1} \approx f - A \cdot ( {U}^{m} + {φ}^{m} ) - B ( {U}^{m} ) - L \cdot {φ}^{m} \\ = {r}^{m} - [ A + L ] \cdot {φ}^{m} \qquad ( 9 ' )$$

At this point, when

Ã=A+L (10)

equation (9′) can be expressed as follows:

r^{m+1}=r^{m}−Ã·φ^{m} (11′)

When, for example, the L² norm is used as the norm for evaluating the amplitude of the nonlinear residual, a norm ∥r^{m+1}∥ of the nonlinear residual r^{m+1} is, in the three-dimensional case, given by the following equation as a square root of a sum of all the inner points of (r^{m+1})²:

$$‖ {r}^{m + 1} ‖ = \sqrt{{\sum }_{ijk} {( {r}^{m} - \tilde{A} \cdot {φ}^{m} )}^{2}} \qquad ( 12 ' )$$

The residual minimization coefficient α₁(1=1, 2, 3, . . . , Lₘₐₓ) is determined so as to minimize the norm ∥r^{m+1}∥ of the nonlinear residual rₘ₊₁ by the least squares method. Specifically, the following equation is to be satisfied:

$$\frac{\partial {‖ {r}^{m + 1} ‖}^{2}}{\partial {α}_{l}} = 0 ( l = 1 , 2 , 3 , ⋯ , {L}_{max} ) \qquad ( 13 )$$

Equation (13) is the Lₘₐₓ-element simultaneous equations, and when this equation is numerically solved, α₁ can be defined. When α₁ is defined, φ^{m} is found on the basis of equation (6), and U^{m+1} is found on the basis of equation (7). The method for calculating the residual minimization coefficient α₁ will be described later.

While incrementing the number m, similar routines are repeated, so as to attain convergence of the solution U for making zero or minimizing the norm of the nonlinear residual of equation (8).

Now, the control method of this embodiment will be described with reference to the flowchart of FIG. 3.

First, in step SB1, an initial value U⁰ of the physical quantity U to be controlled is set. In step SB2, the number m of repeating times is set to an initial value of 0, and an initial value r⁰ of the nonlinear residual r is set to (f−A·U⁰−B(U⁰)).

Thereafter, procedures of steps SB3 through SB12 are repeatedly executed with the number m of repeating times incremented until the approximate solution U^{m} is converged.

In steps SB3 through SB6, the approximate solution (predicted approximate value) φ^{m} of the following equation is obtained by using an internal solver that executes the existing successive approximation such as the ADI method or the SOR method:

Ã·φ=r^{m}

However, when this equation is to be solved by the existing successive approximation, a very large number of repeated times is required before the convergence for practical use, and hence the calculation takes massive time.

Therefore, in this embodiment, the upper limit Nₘₐₓ of the number of repeating times of the successive calculations is set (steps SB5 and SB6).

When the predicted approximate value φ⁰ is obtained through the procedures of steps SB3 through SB6, the optimization routine is carried out, in steps SB8 and SB9, by using this predicted approximate value φ⁰ so as to obtain a corrected value φ⁰ for minimizing a subsequent nonlinear residual r¹. By using this corrected value φ⁰, a primary approximate value U¹ of the physical quantity and a primary nonlinear residual r¹ can be obtained as follows on the basis of equations (2) and (3):

U¹=U⁰+φ⁰ (14)

r¹=f−A·U¹−B(U¹) (15)

In step SB13, the number m of repeating times is incremented, and the flow returns to step SB3, so as to repeat similar calculations. By repeating these procedures, (U², r²), (U³, r³), . . . , (U^{m}, r^{m}) . . . can be successively obtained, and the norm ∥r^{m}∥ of the nonlinear residual is reduced.

When the number of repeating times is m, an equation used for finding the predicted approximate value φ^{m} in step SB4 is as follows:

Ã·φ=r^{m}

Therefore, on the basis of the corrected approximate value φ^{m} having been optimized through the optimization control routine performed in steps SB8 and SB9, the following equations are obtained in step SB12:

U^{m+1}=U^{m}+φ^{m}

r^{m+1}=f−A·U^{m+1}−B(U^{m+1})

<Method for Obtaining Residual Minimization Coefficient α₁>

At this point, for simplifying the expression, δ is introduced as follows:

δ^{m}=φ^{m}

δ^{m-l+1}=φ^{m-l+1} (wherein l=2, 3, . . . , Lₘₐₓ)

In this case, the corrected approximate value φ^{m} is expressed as follows:

$${φ}^{m} = {\sum }_{l = 1}^{L max} {α}_{l} {δ}^{m - l + 1} \qquad ( 17 )$$

Therefore, the following equation holds:

$${r}^{m + 1} = {r}^{m} - A \cdot {φ}^{m} - B ( {φ}^{m} ) \\ = {r}^{m} - \tilde{A} \cdot {φ}^{m} \qquad ( 18 ' )$$

When this equation is substituted in equation (17), the following is obtained:

$${r}^{m + 1} = {r}^{m} - {\sum }_{l = 1}^{L max} {α}_{l} \tilde{A} \cdot {δ}^{m - l + 1} \qquad ( 19 ' )$$

The residual minimization coefficient α₁ is obtained by using the least squares method under a condition that the L² norm of the nonlinear residual of the (m+1)th order is to be minimized.

$${‖ {r}^{m + 1} ‖}^{2} = {\sum }_{ijk} {( {r}^{m} - {\sum }_{l = 1}^{L max} {α}_{l} \tilde{A} \cdot {δ}^{m - l + 1} )}^{2} \qquad ( 20 ' )$$

When this equation is differentiated with respect to α₁, the following is obtained:

$$\frac{\partial {‖ {r}^{m + 1} ‖}^{2}}{\partial {α}_{l}} = 0 ( l = 1 , 2 , 3 , ⋯ , {L}_{max} ) \qquad ( 21 )$$

As a result of differentiation with respect to α₁, the following is obtained:

$$\frac{\partial {‖ {r}^{m + 1} ‖}^{2}}{\partial {α}_{r}} = - 2 {\sum }_{ijk} [ {r}^{m} - \tilde{A} \cdot {\sum }_{l = 1}^{L max} {α}_{l} {δ}^{m - l + 1} ] \tilde{A} \cdot {δ}^{m - l + 1} , ( {l}^{′} = 1 , 2 , 3 , ⋯ , {L}_{max} ) ∴ {\sum }_{ijk} {\sum }_{l = 1}^{L max} {α}_{l} ( \tilde{A} \cdot {φ}^{m - l + 1} ) ( \tilde{A} \cdot {φ}^{m - {l}^{′} + 1} ) = {\sum }_{ijk} {r}^{m} ( \tilde{A} \cdot {φ}^{m - {l}^{′} + 1} ) , ( {l}^{′} = 1 , 2 , 3 , ⋯ , {L}_{max} ) \qquad ( 25 )$$

When the Lₘₐₓ-element simultaneous linear equations given as equation (25) are solved, the residual minimization coefficient α₁ can be obtained.

In the case where the algorithm according to Embodiment 1 or 2 is applied to the drive control for a vehicle shown in FIG. 1, a predicted correction calculation unit 14 first obtains, through repeated calculations, predicted correction φ^{m} on the basis of the current drive information. Next, an optimal addition correction calculation unit 15 calculates an addition correction φ^{m} of the mth-order. A correction convergence judgment unit 16 ultimately determines whether or not the solutions obtained by the predicted correction calculation unit 14 and the optimal addition correction calculation unit 15 have been converged, so as to determine the optimal control for returning the vehicle to the predetermined orbit. The determined control information is sent to a direction control unit 17 for correcting the drive route of the vehicle.

Although the drive control for a vehicle is herein exemplified to describe the invention, it goes without saying that the invention is applicable to control employed in any of various fields.

Also, the control method can be easily realized by an apparatus equipped with a computer for executing a program for realizing the control method. Furthermore, when the program for realizing the control method is recorded in a computer-readable recording medium, the control method can be realized by allowing a computer to execute the program recorded in the recording medium.

In approximately expressing the nonlinear term, B(U^{m}+φ), terms of higher orders than the second-order are ignored in the expansion equation of the nonlinear coefficient in Embodiment 1 and terms of higher orders than the first-order are ignored in Embodiment 2, but the order in which the expansion is ended is not limited to them. However, in consideration of programmability and the like, it seems that the expansion is practically ended in the first-order or the second-order.

<Application to Numerical Calculation>

The algorithm according to this invention is also applicable to numerical calculation.

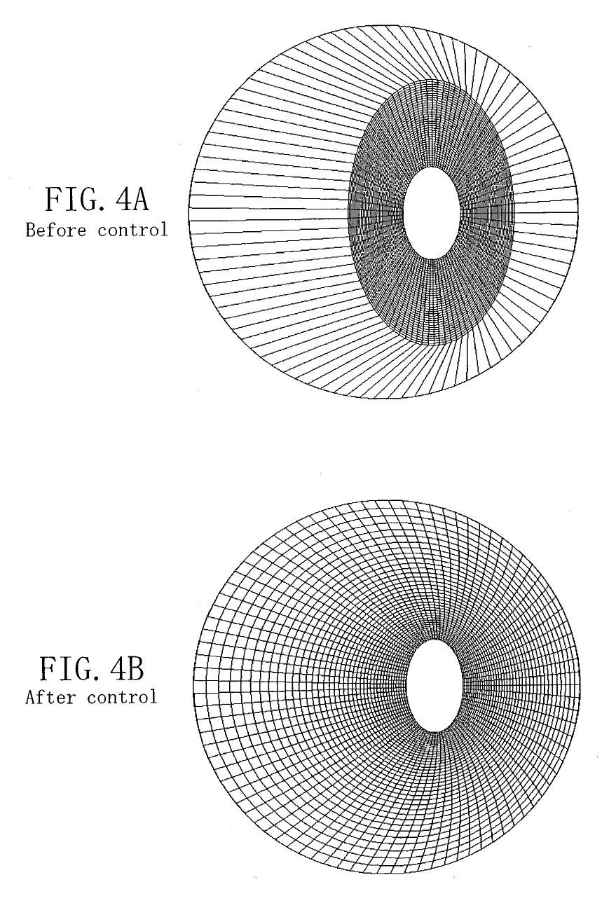

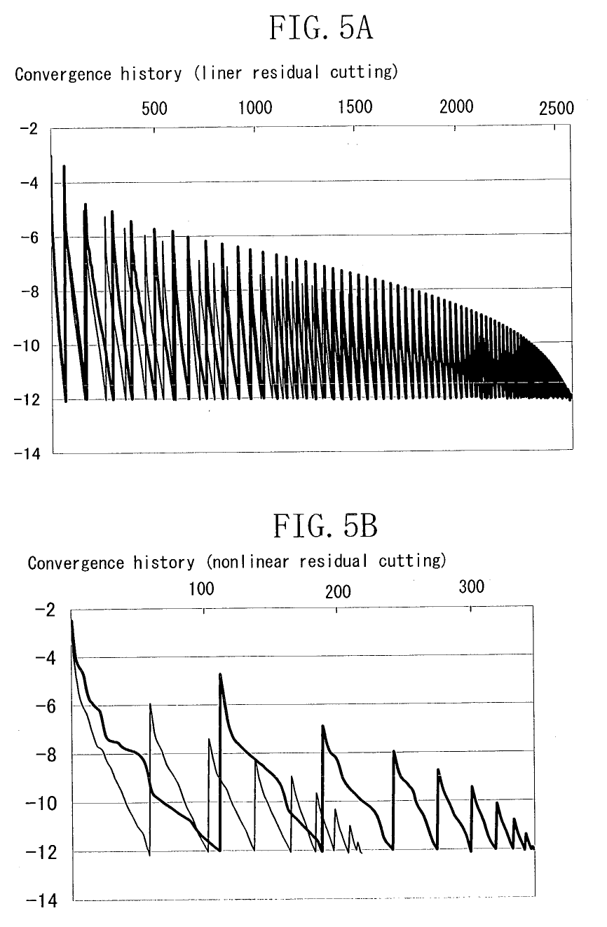

FIGS. 4A and 4B show, as an example of the application to numerical calculation, application to nonlinear simultaneous equations of a two-dimensional Thompson grid generation method. Also, FIGS. 5A and 5B are graphs for showing comparison in the convergence rate in the exemplified application shown in FIGS. 4A and 4B, and specifically, FIG. 5A is a graph obtained by utilizing a conventional linear residual cutting method and FIG. 5B is a graph obtained by using the nonlinear residual cutting method according to Embodiment 1 of the invention. In these graphs, the ordinate indicates the norm of the nonlinear residual (expressed in logarithm) and the abscissa indicates the number of repeating times. In each graph, the norm of the nonlinear residual of an equation for finding the x-coordinate of a grid point is plotted by using a thin line, and the norm of the nonlinear residual of an equation for finding the y-coordinate of a grid point is plotted by using a thick line. It is understood from FIGS. 5A and 5B that the convergence rate is remarkably improved by the invention.

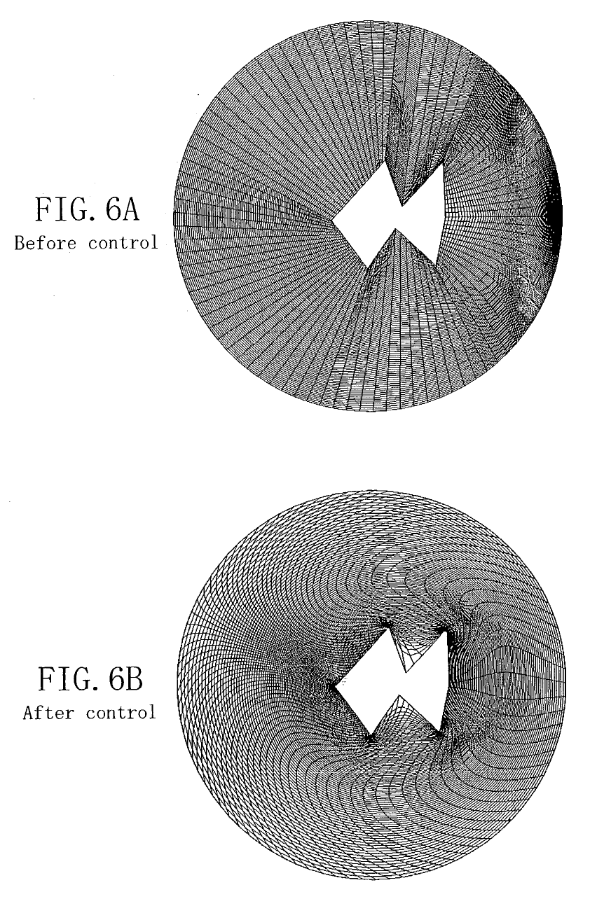

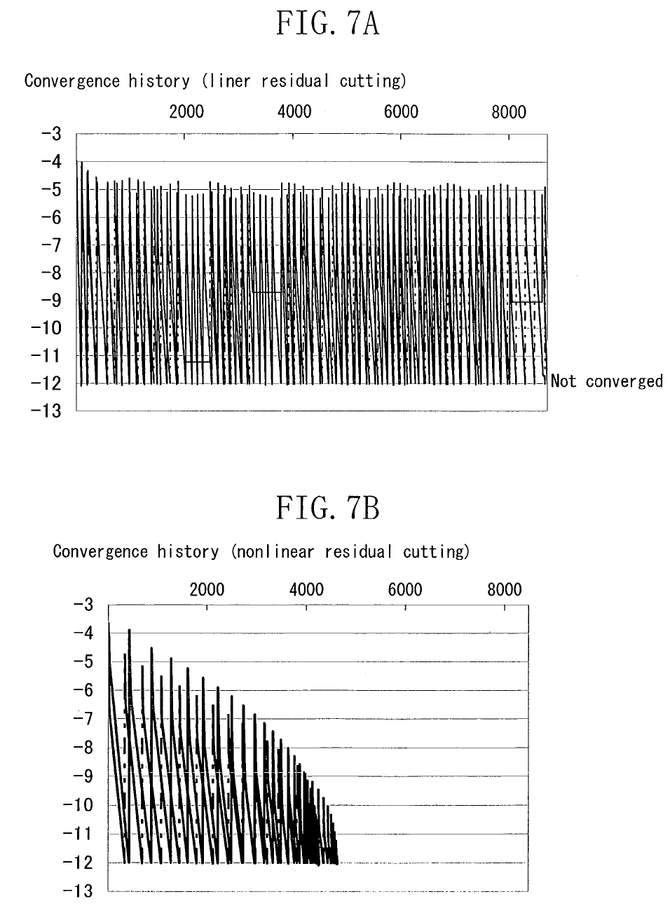

Similarly, FIGS. 6A and 6B show, as an example of the application to numerical calculation, application to the nonlinear simultaneous equations of the two-dimensional Thompson grid generation method. Also, FIGS. 7A and 7B are graphs for showing comparison in the convergence rate in the exemplified application shown in FIGS. 6A and 6B, and specifically, FIG. 7A is a graph obtained by utilizing the conventional linear residual cutting method and FIG. 7B is a graph obtained by using the nonlinear residual cutting method according to Embodiment 2 of the invention. In these graphs, the ordinate indicates the norm of the nonlinear residual (expressed in logarithm) and the abscissa indicates the number of repeating times. In each graph, the norm of the nonlinear residual of an equation for finding the x-coordinate of a grid point is plotted by using a thin line, and the norm of the nonlinear residual of an equation for finding the y-coordinate of a grid point is plotted by using a thick line. It is understood from FIGS. 7A and 7B that even when a solution is not converged by the conventional method, it can be converged by the method of this invention.

Such application to numerical calculation can be easily realized by an apparatus equipped with a computer for executing a program for realizing the calculation. Furthermore, when the program for realizing the calculation is recorded in a computer-readable recording medium, the calculation can be realized by allowing a computer to execute the program recorded in the recording medium.

As described so far, since the present invention employs the successive approximation algorithm in which a nonlinear residual is directly dealt with so as to be reduced, definite and rapid control for a nonlinear operation with strong nonlinearity can be easily performed.

What is claimed is:

1. A method for controlling a physical quantity U, comprising:
a step of solving, by successive approximation, A·U+B(U)=f, wherein A is a linear differential operator, B is a nonlinear differential operator, and f is an inhomogeneous term (source term) in a nonlinear partial differential equation to be satisfied by said physical quantity U,
wherein (f−A·U^{m}−B(U^{m})) is given as a nonlinear residual r^{m} of an approximate solution U^{m}, wherein m is the number of repeating times, and
said approximate solution U^{m} is corrected so as to reduce a nonlinear residual r^{m+1} employed in a subsequent step.

2. The method for controlling a physical quantity U of claim 1,
wherein the nonlinear term B(U) is expressed as follows:
$$B ( U ) = {\sum }_{n} {N}^{n} ( U ) {D}^{n} \cdot U$$
$${N}^{n} ( U ) ⋯$$
. . . nonlinear coefficient,
$${D}^{n} ( U ) ⋯$$
. . . differential operator
N(U^{m}+φ) is expanded with respect to said approximate solution U^{m} and a perturbation quantity φ by the Taylor expansion or the mean value theorem, to give the following with terms higher than φ² ignored:
$$B ( {U}^{m} + φ ) ≅ B ( {U}^{m} ) + L \cdot φ + φ {\sum }_{n} {{N}^{′}}^{n} ( {U}^{m} ) {D}^{n} \cdot φ , \\ L \cdot φ ≡ {\sum }_{n} [ {N}^{n} ( {U}^{m} ) {D}^{n} + {{N}^{′}}^{n} ( {U}^{m} ) {D}^{n} \cdot {U}^{m} ] φ , \\ {{N}^{′}}^{n} ( {U}^{m} ) ≡ {[ \frac{\partial {N}^{n} ( U )}{\partial U} ]}_{U = {U}^{m}} \qquad ( 4 )$$
wherein a first process and a second process are repeatedly executed until said approximate solution U^{m} is converged,
wherein said first process includes the steps of:
setting U⁰ as an initial value of said physical quantity U;
setting 0 as an initial value of said number m of repeating times and (f−A·U⁰−B(U⁰)) as an initial value r⁰ of a nonlinear residual r; and
obtaining a predicted approximate value φ^{m} of the following equation through repeated calculations while incrementing said number m of repeating times:
$$[ A + L + φ {\sum }_{n} {{N}^{′}}^{n} ( {U}^{m} ) {D}^{n} ] \cdot φ = {r}^{m} \qquad ( 5 )$$
and
wherein said second process includes the steps of:
obtaining a corrected approximate value φ^{m} for minimizing a norm of a nonlinear residual r^{m+1} on the basis of a predicted approximate value φ^{m} and corrected approximate values φ^{m-1}, . . . , and φ^{m-Lmax+1}, wherein Lmax is an integer of 2 or more;
giving (U^{m}+φ^{m}) as an approximate solution U^{m+1}; and
giving (f−A·U^{m+1}−B(U^{m+1})) as said nonlinear residual r^{m+1}.

3. The method for controlling a physical quantity U of claim 1,
wherein the nonlinear term B(U) is expressed as follows:
$$B ( U ) = {\sum }_{n} {N}^{n} ( U ) {D}^{n} \cdot U$$
$${N}^{n} ( U ) ⋯$$
. . . nonlinear coefficient,
$${D}^{n} ( U ) ⋯$$
. . . differential operator
N(U^{m}+φ) is expanded with respect to said approximate solution U^{m} and a perturbation quantity φ by the Taylor expansion or the mean value theorem, to give the following with terms higher than φ ignored:
B(U^{m}+φ)≅B(U^{m})+L·φ, (4′)
$$L \cdot φ ≡ {\sum }_{n} [ {N}^{n} ( {U}^{m} ) {D}^{n} + {{N}^{′}}^{n} ( {U}^{m} ) {D}^{n} \cdot {U}^{m} ] φ , \\ {{N}^{′}}^{n} ( {U}^{m} ) ≡ {[ \frac{\partial {N}^{n} ( U )}{\partial U} ]}_{U = {U}^{m}}$$
wherein a first process and a second process are repeatedly executed until said approximate solution U^{m} is converged,
wherein said first process includes the steps of:
setting U⁰ as an initial value of said physical quantity U;
setting 0 as an initial value of said number m of repeating times and (f−A·U⁰−B(U⁰)) as an initial value r⁰ of a nonlinear residual r; and
obtaining a predicted approximate value φ^{m} of [A+L]φ=r^{m} through repeated calculations while incrementing said number m of repeating times, and
wherein said second process includes the steps of:
obtaining a corrected approximate value φ^{m} for minimizing a norm of a nonlinear residual r^{m+1} on the basis of a predicted approximate value φ^{m} and corrected approximate values φ^{m-1}, . . . , and φ^{m-Lmax+1}, wherein Lmax is an integer of 2 or more;
giving (U^{m}+φ) as an approximate solution U^{m+1}; and
giving (f−A·U^{m+1}−B(U^{m+1})) as said nonlinear residual r^{m+1}.

4. A controller for controlling a physical quantity U, comprising:
means for solving, by successive approximation, A·U+B(U)=f, wherein A is a linear differential operator, B is a nonlinear differential operator, and f is an inhomogeneous term (source term) in a nonlinear partial differential equation to be satisfied by said physical quantity U,
wherein (f−A·U^{m}−B(U^{m})) is given as a nonlinear residual r^{m} of an approximate solution U^{m}, wherein m is the number of repeating times, and
said approximate solution Um is corrected so as to reduce a nonlinear residual r^{m+1} employed in a subsequent step.

5. A recording medium in which a control program for allowing a computer to control a physical quantity U is recorded, said program allowing said computer to execute:
a processing for solving, by successive approximation, A·U+B(U)=f, wherein A is a linear differential operator, B is a nonlinear differential operator, and f is an inhomogeneous term (source term) in a nonlinear partial differential equation to be satisfied by said physical quantity U,
a processing for giving (f−A·U^{m}−B(U^{m})) as a nonlinear residual r^{m} of an approximate solution U^{m}, wherein m is the number of repeating times, and
a processing for correcting said approximate solution U^{m} so as to reduce a nonlinear residual r^{m+1} employed in a subsequent step.

6. A method for numerically calculating a physical quantity U, comprising:
a step of solving, by successive approximation, A·U+B(U)=f, wherein A is a linear differential operator, B is a nonlinear differential operator, and f is an inhomogeneous term (source term) in a nonlinear partial differential equation to be satisfied by said physical quantity U,
wherein (f−A·U^{m}−B(U^{m})) is given as a nonlinear residual rr of an approximate solution U^{m}, wherein m is the number of repeating times, and
said approximate solution U^{m} is corrected so as to reduce a nonlinear residual r^{m+1} employed in a subsequent step.

7. A numerical calculator for calculating a physical quantity U, comprising:
means for solving, by successive approximation, A·U+B(U)=f, wherein A is a linear differential operator, B is a nonlinear differential operator, and f is an inhomogeneous term (source term) in a nonlinear partial differential equation to be satisfied by said physical quantity U,
wherein (f−A·U^{m}−B(U^{m})) is given as a nonlinear residual r^{m} of an approximate solution U^{m}, wherein m is the number of repeating times, and
said approximate solution U^{m} is corrected so as to reduce a nonlinear residual r^{m+1} employed in a subsequent step.

8. A recording medium in which a numerical calculation program for allowing a computer to numerically calculate a physical quantity U, said numerical calculation program allowing said computer to execute:
a processing for solving, by successive approximation, A·U+B(U)=f, wherein A is a linear differential operator, B is a nonlinear differential operator, and f is an inhomogeneous term (source term) in a nonlinear partial differential equation to be satisfied by said physical quantity U,
a processing for giving (f−A·U^{m}−B(U^{m})) as a nonlinear residual rr of an approximate solution U^{m}, wherein m is the number of repeating times, and
a processing for correcting said approximate solution U^{m} so as to reduce a nonlinear residual r^{m+1} employed in a subsequent step.
